(19) United States
(12) Patent Application Publication
(10) Pub. No.: US 2002/0136860 A1
(43) Pub. Date: Sep. 26, 2002

(54) Decorative frog structure

(75) Inventor: Tai-Kuang Wang, Taipei (TW)

Correspondence Address: David E Dougherty, Dennison Schultz & Dougherty, 612 Crystal Square 4, 1745 Jefferson Davis Highway, Arlington, VA, 22202, US

(73) Assignee: Wei Hsu Co., Ltd.

(21) Appl. No.: 09/812,588

(22) Filed: Mar. 21, 2001

(51) Int. Cl. B32B 3/06

(52) U.S. Cl. 428/99

(57) ABSTRACT

A decorative frog structure comprising: a decorative piece and a catch piece, wherein, the decorative piece has a decoration zone and at least an latching protrusion; the catch piece has at least an engaging hole mating with the latching protrusion, the decorative piece and the catch piece can be firmly connected to an article to be decorated. With a pattern or a brand of a manufacturer provided on the decoration zone to add to the visual effect, an effect of decoration can be conveniently achieved.

### BACKGROUND OF THE INVENTION

The present invention is related to a decorative frog structure convenient for use and able to make firm connection, and especially to a decorative frog structure suitable for use in the products such as costumes, purses and hats etc., the products can thus have the features of novelty and beauty.

Quality requirements of people's life have been being elevated from day to day, as to the clothing, it is not the primary object to keep warmness any more, rather, modeling, matching of clothes and their accessories (such as hats, necktie clip, jewels and purses etc.) have been getting the important positions.

Taking the products such as hats and costumes as examples, the ornaments on these products most often have some patterns or marks printed directly thereon; otherwise, the patterns or marks can be made in advance, and then are connected with the products to be decorated by sewing or stapling. Both the modes of connecting can not have the patterns or marks separated from the products to be decorated. And sewing or stapling needs sewing lines or staplers; they not only increase cost of production, but also restrain the scope of application of the ornaments, and thereby are not desired.

Accordingly, it is the motive of the present invention to get rid of the defects resided in the conventional connecting mode for the patterns or marks and to provide a delicate decorative frog structure which can be firmly positioned at a desired position on an article to be decorated and can be freely changed, or matched with something else, in order that the article can show various visual sense of beauty.

### SUMMARY OF THE INVENTION

The primary object of the present invention is to provid decorative frog structures which is convenient for firm positioning.

The secondary object of the present invention is to provide decorative frog structures which are variant in colors, modeling and patterns.

Another object of the present invention is to provide decorative frog structures which can be freely matched with something else, in order to show various visual sense of beauty.

For obtaining the above objects, the present invention is comprised of: a decorative piece and a catch piece. Wherein, the decorative piece has a decoration zone and at least a latching protrusion; the catch piece has at least an engaging hole mating with the latching protrusion. With a pattern or a brand of a manufacturer provided on the decoration zone to add to the visual effect, an effect of decoration can be conveniently achieved.

The present invention will be apparent in its particular structure and characteristics after reading the detailed description of the preferred embodiment thereof in reference to the accompanying drawings.

### BRIEF DESCRIPTION OF THE DRAWINGS

FIG. 1 is a perspective view of an embodiment of the present invention;

FIG. 2 is perspective schematic view showing connecting of the present invention to a hat;

FIG. 3 is a sectional view taken from a section line a-a from FIG. 2;

FIG. 4 is a perspective view of a second embodiment of the present invention.

### DETAILED DESCRIPTION OF THE PREFERRED EMBODIMENT

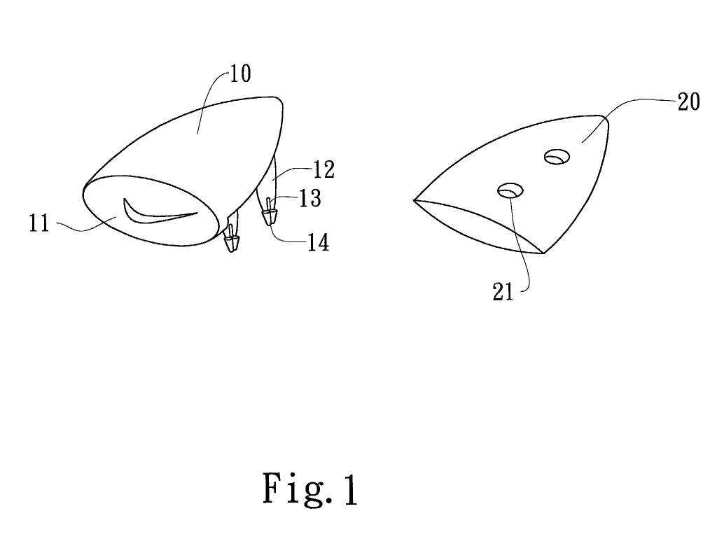

Referring firstly to FIG. 1, the present invention is comprised of a decorative piece 10 and a catch piece 20. Wherein, the decorative piece 10 is made of plastic, silicone, metal or other material, and has a decoration zone 11 to be provided thereon with any of various patterns, figures or marks. The decorative piece 10 is provided on the bottom thereof with two latching protrusions 12 (the decoration zone 11 is orthogonal or parallel to the latching protrusions 12). The latching protrusions 12 are provided each on the center of its bottom a slit 13 of suitable length to divide each latching protrusion 12 into two legs, the ends of the latching protrusions 12 are provided with studs 14.

The catch piece 20 is in the form of a sheet with a suitable size, which has engaging holes 21 mating with the latching protrusions 12 of the decorative piece 10.

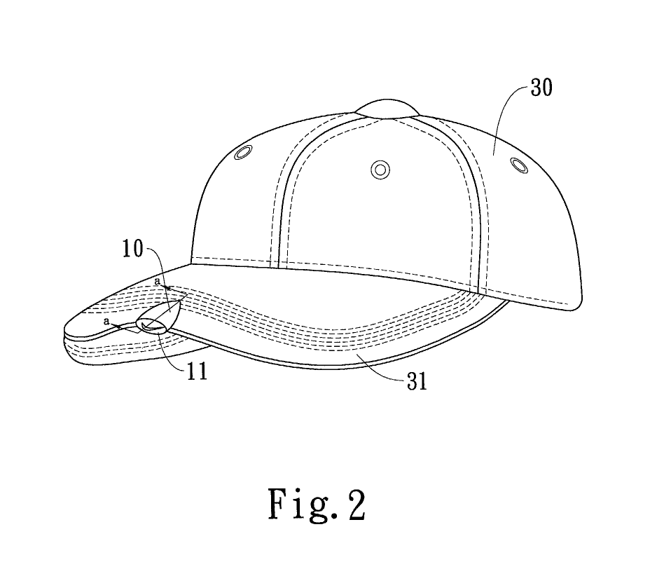

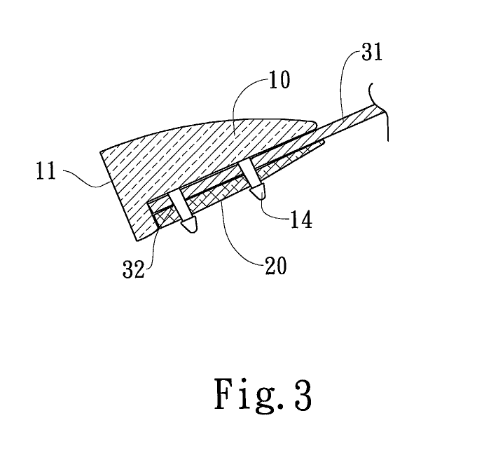

As shown in FIG. 2, if the article to be decorated is a hat 30, a visor 31 of the hat 30 has thereon holes 32 suiting the widths of the latching protrusions 12, the latching protrusions 12 of the decorative piece 10 extend through the holes 32 from above, then the catch piece 20 is placed under the visor 31 with the engaging holes 21 thereof in engagement with the latching protrusions 12 of the decorative piece 10. The studs 14 are engaged with the catch piece 20 by their resilience after being pressed through the holes in catch piece 20; thereby, the decorative piece 10 firmly connects to the visor 31 (as shown in FIG. 3). In this way, the decoration zone 11 provided with a pattern, a feature or a mark can be seen apparently to get the effect of beautifying and decoration. If a different decorative piece is to change for the decorative o piece 10, it needs only to press the two lateral sides of each latching protrusions 12 inwardly to render the studs 14 to contract into the engaging holes 21 for separating the decorative piece 10 from the catch piece 20.

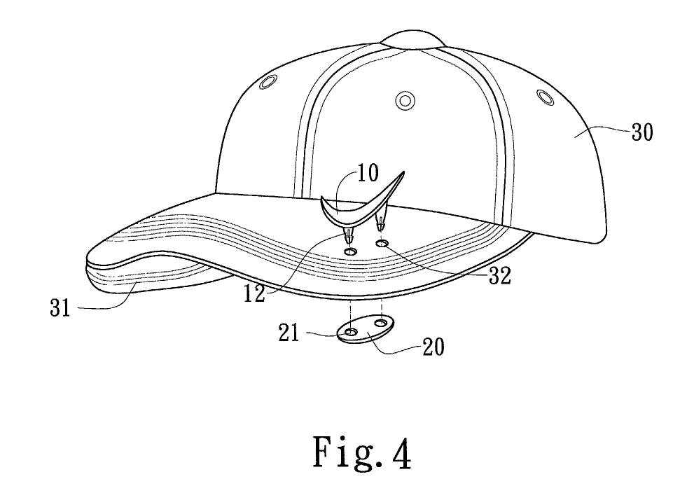

And more, please also refer to FIG. 4 which shows a second embodiment of the present invention, wherein, the decorative piece 10 is directly provided with a decorative pattern, the latching protrusions 12 are provided on the rear side of the decorative piece 10. The visor 31 of the hat 30 has thereon two holes 32, the latching protrusions 12 of the decorative piece 10 are extended through the two holes 32; then the catch piece 20 is placed with the engaging holes 21 thereof in engagement with the latching protrusions 12 of the decorative piece 10 to get firm connection.

The decorative frog structure of the present invention has the following advantages:

1. Manufacturing of the decorative frog structure and connecting of it with the article to be decorated are both quite delicate and convenient; the decorative frog structure can also be done matching with the article to be decorated.

2. The decorative frog structures of the present invention can have various colors, modeling and patterns, so that the article to be decorated can have variant effects of decoration.

3. The present invention can be connected to the article to be decorated at a location most apparent to get an object of decoration and advertisement.

In conclusion, the decorative frog structure of the present invention not only is convenient in manufacturing, but also has the effect of beautifying the article to be decorated, the structure has never existed in the markets, therefore,

What I claim as new and desire to be secured by Letters Patent of the United States are:

1. A decorative frog structure comprising: a decorative piece and a catch piece, wherein, said decorative piece has a decoration zone and at least an latching protrusion; said catch piece has at least an engaging hole mating with said latching protrusion, said structure is characterized by that said decorative piece and said catch piece are firmly connected to each other.

2. A decorative frog structure as in claim 1, wherein, said decoration zone of said decorative piece is orthogonal to said latching protrusion.

3. A decorative frog structure as in claim 1, wherein, said decoration zone of said decorative piece is parallel to said latching protrusion.

4. A decorative frog structure as in claim 1, wherein, said latching protrusion of said decorative piece is provided with a stud.

5. A decorative frog structure as in claim 1, wherein, said decorative piece is directly provided as said decorative zone.
